(19) United States
(12) Patent Application Publication
(10) Pub. No.: US 2013/0057286 A1
(43) Pub. Date: Mar. 7, 2013

(54) METAL DETECTOR SENSOR HEAD

(71) Applicant: Alexander Lewis Jones, Torrensville (AU)

(72) Inventor: Alexander Lewis Jones, Torrensville (AU)

(73) Assignee: MINELAB ELECTRONICS PTY LIMITED, Torrensville, SOUTH AUSTRALIA (AU)

(21) Appl. No.: 13/636,659

(22) PCT Filed: Mar. 22, 2011
(86) PCT No.: PCT/AU2011/000322

§ 371 Date: Nov. 21, 2012

(30) Foreign Application Priority Data
Mar. 24, 2010 (AU) 2010901249

(51) Int. Cl. G01V 3/11

(52) U.S. Cl. 324/329

(57) ABSTRACT

A method for improving a sensitivity of a metal detector by reducing an unwanted magnetic field generated by at least one electrically conductive element of the metal detector, the metal detector transmitting a transmit magnetic field into a soil and a possible target within the soil which in response generate a response magnetic field, the method including the step of: redirecting at least a portion of the response magnetic field from entering the at least one electrically conductive element, wherein otherwise the at least one electrically conductive element within an influence of the response magnetic field generates the unwanted magnetic field due to a change in an intensity of the response magnetic field entering the at least one electrically conductive element, the redirecting adapted to reduce or eliminate the unwanted magnetic field generated by the at least one electrically conductive element thereby improving the sensitivity of the metal detector.

### INCORPORATION BY REFERENCE

This patent application claims priority from:
Australian Provisional Patent Application No 2010901249 titled “Improvements inn Metal Detector Sensor Head” filed 24 Mar. 2010.

The entire content of this application is hereby incorporated by reference.

### TECHNICAL FIELD

This invention pertains to metal detectors, particularly those that transmit time-varying magnetic fields to induce eddy currents in both ferrous and non-ferrous metallic targets, then detect the magnetic fields concomitant with the induced eddy currents.

### BACKGROUND OF THE INVENTION

Over many decades there have been improvements in the performance of metal detectors that transmit time-varying magnetic fields to illuminate sought targets. One motive for improvement is the desire for greater sensitivity to a greater range of targets. To this end, improvements such as higher dynamic range in the receive electronics, improvement in the ability to reject the signal from mineralised ground (also known as magnetic ground/soil) and increased sensitivity to smaller targets have been developed. At various times, an improvement has exposed deficiencies in aspects of the detector other than the electronics.

The principle of detection of electrically conductive targets with a detector arrangement is that the detector transmits a time-varying magnetic field which induces eddy currents in electrically conductive targets within the influence of the time-varying magnetic field. Any such eddy current produces its own magnetic field that induces a signal in the receiver of the sensor head of the detector. Any electrically conductive object within range of the transmit magnetic field will have eddy currents induced in it. This includes any electrically conductive elements within or near the sensor head.

During operation of the detector, magnetic ground also produces a magnetic field in response to the transmit magnetic field. The sensitivity of a metal detector to detect a wanted target may be reduced if the varying intensity of the magnetic field produced by magnetic ground induces eddy currents of varying initial magnitudes in electrically conductive components that are within or near the sensor head of the detector.

This invention is directed to a method and means of reducing the induction of eddy currents in electrically conductive elements of a sensor head, and has application in both continuous wave (CW) and pulse induction (PI) detectors.

### SUMMARY OF INVENTION

According to a first aspect of the present invention, there is provided a method for improving a sensitivity of a metal detector by reducing an unwanted magnetic field generated by at least one electrically conductive element of the metal detector, the metal detector transmitting a transmit magnetic field into a soil and a possible target within the soil which in response generate a response magnetic field, the method including the step of:
redirecting at least a portion of the response magnetic field from entering the at least one electrically conductive element, wherein otherwise the at least one electrically conductive element within an influence of the response magnetic field generates the unwanted magnetic field due to a change in an intensity of the response magnetic field entering the at least one electrically conductive element, the redirecting adapted to reduce or eliminate the unwanted magnetic field generated by the at least one electrically conductive element thereby improving the sensitivity of the metal detector.

According to a second aspect of the present invention, there is provided metal detector capable of transmitting a transmit magnetic field and receiving a response magnetic field for detecting a target in a soil, including:
at least a magnetic field redirecting element for redirecting at least a portion of the response magnetic field from entering an at least one electrically conductive element, wherein otherwise the at least one electrically conductive element within an influence of the response magnetic field generates the unwanted magnetic field due to a change in an intensity of the response magnetic field entering the at least one electrically conductive element, the redirecting element adapted to reduce or eliminate the unwanted magnetic field generated by the at least one electrically conductive element thereby improving a sensitivity of the metal detector.

In one form, the magnetic field redirecting element is made of a material with a relative magnetic permeability greater than 1.

In one form, the relative magnetic permeability is a substantially real number over a predetermined range of operational frequencies.

In one form, the material is ferrite.

In one form, the metal detector includes a transmit coil for transmitting magnetic fields and a receive coil for receiving response magnetic fields; and wherein the at least one magnetic field redirecting element is substantially stationary with respect to the transmit coil and the receive coil.

In one form, the transmit coil and the receive coil are the same coil.

In one form, the at least one electrically conductive element of the metal detector includes a volume of solder joint.

In one form, the at least one electrically conductive element of the metal detector includes a circuit board.

In one form, the at least one electrically conductive element of the metal detector includes a position or motion sensor.

### BRIEF DESCRIPTION OF THE DRAWINGS

FIG. 1 depicts an exemplar of a metal detector in operation;

FIG. 2 depicts a representation of an example of sensor head;

FIG. 3 depicts a cross-section of a volume of an exemplar solder joint within sensor head;

FIG. 4 depicts a hollow cylindrical ferrite for covering a soldered joint;

FIG. 5 shows an end-on, cross-section view of the effect of the ferrite with high magnetic permeability upon some of the field lines of a magnetic field;

FIG. 6 depicts a circuit board shielded from a magnetic field;

FIG. 7 depicts a simple graphical representation of a modulated time-varying response field at a point within the influence of the transmit magnetic field; and

FIG. 8 depicts a hollow cylindrical ferrite for covering two soldered joints.

### DETAILED DESCRIPTION OF THE INVENTION

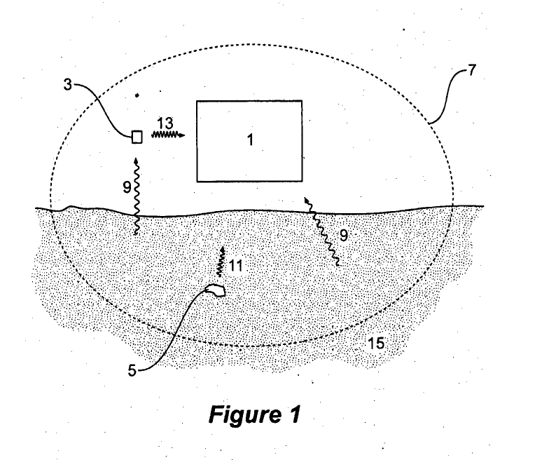

FIG. 1 depicts an exemplar of a metal detector in operation. In this exemplar, the sensor head 1 of a metal detector (not shown) includes a magnetic field transmitter and a magnetic field receiver. It is possible to have the magnetic field transmitter and the magnetic field receiver at different locations. It is also possible to have the magnetic field transmitter and the magnetic field receiver being the same entity that is a single coil acts as both the magnetic field transmitter and the magnetic field receiver.

Referring to FIG. 1, during the operation of the metal detector, the sensor head 1 is moved, or swept, near the surface of ground 15, and the magnetic field transmitter transmits a transmit magnetic field (not shown). Dotted line 7 defines an exemplary influence space of the transmit magnetic field. An object within the influence space would be considered within or under the influence of the transmit magnetic field. Eddy currents are induced in any electrically conductive object within the influence space. The influence space in FIG. 1 is purely for illustrative purposes. In actual fact, the influence space would largely depend on the type of magnetic field transmitter used.

A electrically conductive object under the influence of the transmit magnetic field would have eddy currents induced in it, and the eddy currents would generate a magnetic field. For example, target 5, when within influence space 7, generates magnetic field 11. Magnetic field 11 is received by the receiver and processed to provide an indicator output signal, indicating the presence of target 5.

It seems natural to suppose that small targets are harder to detect, with a metal detector, than larger targets because they intercept less of the transmit magnetic field and, therefore, reflect less magnetic field to the receiver. It is true that small targets generally do reflect less energy, but it is not only because of their lesser spatial cross-section; the degree to which a target receives and reflects the transmit magnetic field also depends upon the relationship between the frequency components of the transmit magnetic field and the dominant time constants (TC) of decay of eddy currents in the target, the “spectral cross-section” of the target in the transmit magnetic field.

The rates at which the induced eddy currents of targets decay, the TC, are determined by the shape, size, resistivity and magnetic permeability of the material. For simplicity in this description, the relative magnetic permeability of the targets will be assumed to be equal to one, a reasonable assumption for non-ferrous targets. The general trends for TCs of a target are:
the lesser volume of individual parts of a target produce shorter TCs in eddy currents;
the greater the resistivity of the constituent Material, the shorter the TCs in eddy currents;
thin, widely distributed targets have shorter TCs than compact targets of the same volume.

The targets with shorter TCs respond better to transmit magnetic field components of higher frequency, while targets with longer TCs respond better to transmit magnetic field components of lower frequency. In CW detectors with discrete frequencies of transmit magnetic field, targets of shorter TC will more readily reflect the transmit magnetic field of the higher frequencies.

In PI detectors, this translates to the delay between the ends of transmit pulses of magnetic field and the starts of samples being taken of the receive signal; the shorter that delay, the shorter the longest TC that is excluded from contributing to the samples taken of the receive signal.

The ground 15 may be magnetic, or contain other undesirable electrically conductive objects which, when under the influence of the transmit magnetic field, generate magnetic field. For example, ground 15 generates magnetic fields 9. In order to have some chance of consistently detecting small targets with short TC such as fine grains of gold or the firing pins of minimum-metal landmines, in a variety of environments, a metal detector must have excellent rejection of ground mineralisation, large dynamic range in the receive electronics, emit strong high-frequency components in the transmit magnetic field and the ability to demodulate signals of relatively high frequency as they are reflected by targets.

Further, electrically conductive element 3 near the sensor head 1 (or in other examples discussed later, within the sensor head 1) also generates magnetic field 13 when under the influence of the transmit magnetic field. Magnetic field purely due to the influence of the transmit magnetic field can be easily cancelled. However, the magnetic field 13 may not be solely due to the influence of the transmit magnetic field, and may also due to the magnetic field from the ground (for example, magnetic field 9 from ground 15) and possibly the magnetic field due to other objects (for example, magnetic field 11 from target 5). Such magnetic field 13 may affect the operation of the metal detector, or worse, cause the metal detector to indicate electrically conductive object 3 as a target. The invention described herein aims to reduce or eliminate this problem.

FIG. 2 shows a representation of an example of sensor head 1. The outer shell 21 houses receive winding 23 as the receiver, and transmit winding 25 as the transmitter. The two windings (23 and 25) are connected with soldered joints (27 and 29, respectively) to the cables with the leads 31 that connect sensor head 1 to the control box or signal processing unit (not shown). The windings (23 and 25) are often made of Litzendraht wire, or at least fine, individually insulated, electrically parallel strands of conductor, in order to prevent the generation of eddy currents with relatively long TC in the windings.

As mentioned previously, sought targets are not the only objects that are within the influence of the transmit magnetic field of the sensor head. Any electrically conductive object within the influence would have eddy currents induced in it. Examples include, and are not limited to, soldered joints (for example, soldered joints 27 and 29), which will be discussed in further details below.

By necessity, the windings (23 and 25) are made of highly electrically conductive wire, usually copper, and are soldered to the leads 31 that connect these windings to the control box of the metal detector. These solder joints are usually posited within the sensor head, that is within the influence of the transmit magnetic field.

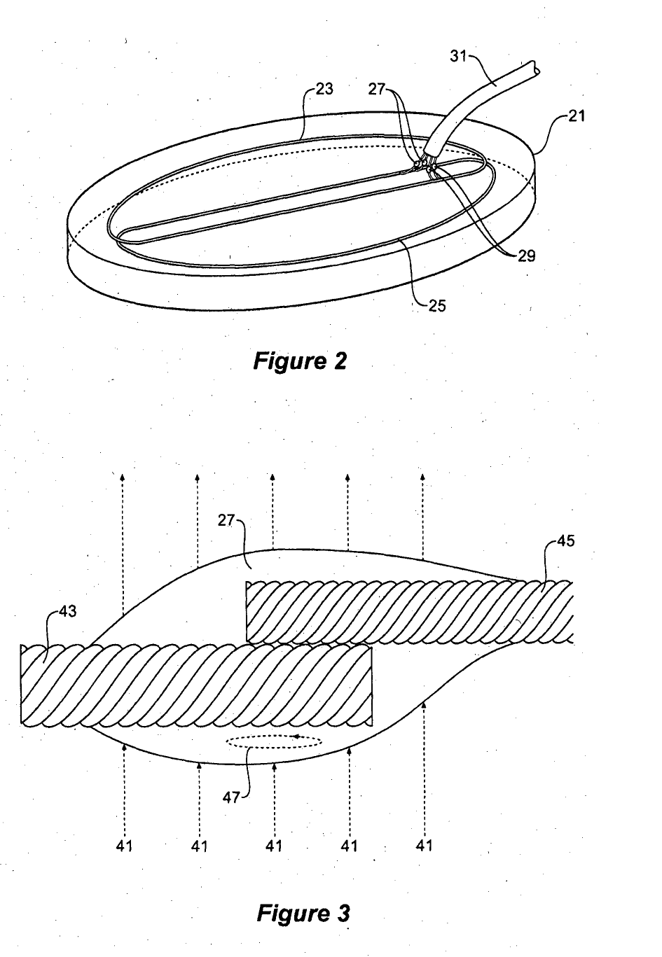

FIG. 3 shows a representation of across-section of a volume of an exemplar solder joint within sensor head 1. A time-varying magnetic field is represented by the field lines 41. The cable 43 of, for example, winding 23 in the sensor head 1 is shown, along with the cable 45 to which cable 43 is connected with the solder joint 27. Cable 45 connects the winding 23, through cable 43, to the processing unit of a metal detector. A stylised representation of an eddy current 47, induced by the time-varying magnetic field 41, is shown. The direction of the eddy current 47 depends upon whether the intensity of the time-varying magnetic field 41 is increasing, or decreasing, with time, as well as the direction of the field.

Each strand of the cables (43 & 45) is coated with an electrical insulator, often a thin skin of polyurethane, reducing the tendency for a metal detector to see the cables and windings of the sensor head 1 as a target. At the ends of the cable 43 and cable 45, depicted in FIG. 2, it is a requirement that the insulation of the individual strands of the cables is removed, in order that good electrical connection is made between the two cables and that the joint is as physically stable as it can be. Thus, the entire volume of the solder joint 27 is one continuous body of electrically conductive metal, and it can happen that this volume allows for the induction of eddy currents of sufficiently long TC to be seen by a metal detector with sensitivity to small targets, possible causing the metal detector to falsely indicate of a sought target. This reduces the effective sensitivity of the metal detector.

The detectable electrically conductive elements within or near a sensor head need not be the solder joints just described. Any piece of electrically conductive metal, whether or not it carries an electrical current as part of some circuit, is capable of sustaining eddy currents induced by the response magnetic field from soil and/or targets.

The nature of time-varying transmit magnetic fields of metal detectors is cyclic, that is the pattern of transmission is repeated, usually with a fundamental frequency between 100 Hz and 100 kHz. Nominally, the energy transmitted in each cycle is the same as in every other cycle. At any point in space, the magnitude of the magnetic field due to the transmit magnetic fields alone will be the same at every instance of an equivalent moment in every transmit cycle. Such a field will induce eddy currents within electrically conductive elements under the influence of the field, but the magnitudes of those eddy currents will be identical, from each cycle to the next, if the electrically conductive elements are fixed in space with respect to the windings of the sensor head.

Most metal detectors indicate detection only when they detect a difference in the response field. A situation in which the time-varying magnetic field, at an electrically conductive element, has the same energy in each cycle will produce eddy currents that have the same magnitude and produce the same energy in their magnetic fields from each cycle to the next. A metal detector will not indicate a detection in this situation, given that the receive electronics is not driven into a non-linear state by the magnitude of the receive signals caused by such magnetic fields. In other words, the indicator of a motion detector responds to differences in the received signals and, as long as the magnitudes of the synchronous eddy currents are the same from one transmit cycle to the next, there is nothing for the detector to indicate.

In order for a metal detector to indicate a detection due to electrically conductive elements fixed with respect to the windings in its sensor head there must be, at those electrically conductive elements, response fields with varying intensity due to modulation of the time-varying transmit magnetic field. Such modulation can occur as the sensor head 1 of an operating metal detector is moved in the vicinity of some material that generates a response magnetic field that is synchronous with the field transmitted by the detector. The material can be either electrically conductive, or be magnetic, or both.

When used over ground, metal detectors often have to deal with the effects of magnetic ground, that is ground that has a magnetic permeability much greater than 1, and often with complex permeability. These grounds occur in many places around the earth. Gold fields are renowned for having highly magnetic matrix that limits the effective sensitivity of metal detectors used there.

In such grounds, the signal in the receive circuit, even when a target is present, is composed almost entirely of signal reflected by the ground, giving the advantage to those detectors with large dynamic range in the receive electronics and with the ability to identify the signals of the magnetic ground and remove them in order to see the smaller target signal.

As the sensor head is moved over the ground, variations in the ground produce variations in the response field within the sensor, head. These variations can be due to spatial variations in the concentration of magnetic material diffused through the matrix, different distances between the surface of the ground and the sensor head due to rough ground or some vertical movement of the sensor head, or changes in the nature of the magnetic permeability of the ground, or the presence of “hot rocks”.

Such effects can produce variations in the magnitudes of the eddy currents of electrically conductive elements within the sensor head from one transmit cycle to the next, producing changing signals in the receive winding, which might be interpreted by the detector as the detection of a sought target. This is especially true in detectors with large dynamic range, the ability to “balance” magnetic ground and sensitivity to targets with short time constants.

A detector whose receive processes are adapted to cancel the effect of magnetic viscosity of the ground, be it a CW or PI detector, can suffer the effect described here. The effect is of the electrically conductive elements; the role of the magnetic ground is merely to modulate the intensity of the transmit magnetic field to produce variations in the response field irradiating those elements.

This invention is a means and method for increasing the sensitivity of a metal detector by attenuating the intensity of any response magnetic field entering, or preventing any magnetic field from entering, the electrically conductive elements of a sensor head. This can be achieved in one embodiment by shielding such an element, from the response field, with a material with relative magnetic permeability (μᵣ) greater than unity and having a substantially zero imaginary component of its magnetic permeability, that is it has very low loss in the frequencies present in the time-varying magnetic transmit field. In other words, the relative magnetic permeability is a substantially real number over a predetermined range of operational frequencies.

A complete shielding is not necessary, and a partial covering with material of high magnetic permeability and low losses in a time-varying magnetic field, for example low-loss ferrite, may be sufficient.

This will prevent the response field from entering the electrically conductive material, preventing the generation of eddy currents within them. The ferrite, with its low losses, responds to the time-varying field, a combination of directly transmitted field and that reflected by the matrix and any targets it contains, with such little loss as to make its response instantaneous as far as the metal detector is concerned. As long as its position with respect to the windings is fixed, it does not temporally modulate the field at any point in space.

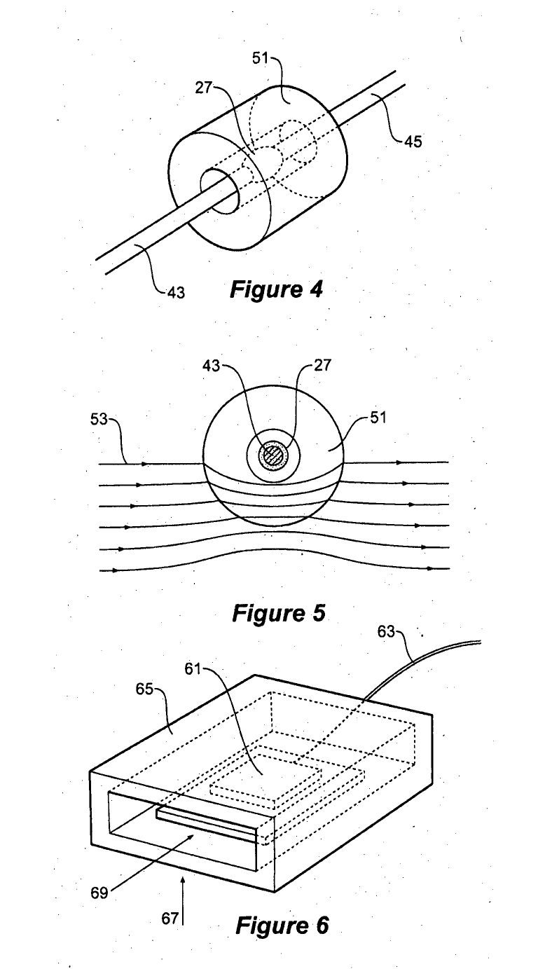

FIG. 4 depicts one embodiment of the present invention. A hollow cylindrical ferrite 51 is positioned as a shield to cover the soldered joint 27. The ferrite 51 may be other shapes/sizes deemed appropriate by a person skilled in the art.

FIG. 5 shows an end-on, cross-section view of the effect of the ferrite 51 with high magnetic permeability upon some of the field lines of a magnetic field. A time-varying magnetic field 53 is redirected from the space defined by the hollow space of the ferrite 51 by the wall of the ferrite 53. There would be only negligible eddy current induced by the magnetic field 53 in soldered joint 27 posited within the ferrite 53. Even if there were a significant eddy current (not shown), its concomitant magnetic field would be attenuated by the ferrite 53.

FIG. 6 shows another embodiment of the present invention, where the conducting object of concern is a circuit board 61 positioned within or near the sensor head (not shown). The circuit board 61 is connected to the processing unit through cable 63. It is also possible for the communication between the circuit board 61 and the processing unit to be in wireless format.

To prevent the problem mentioned above, the circuit board 61 may be positioned within a shield 65. It is not necessary for the shield 65 to cover the circuit board 61 completely. Depending on the orientation of the circuit board with respect to the ground, the shape and orientation of the shield may be selected accordingly. For example, if the magnetic field from the ground is primarily from direction 67, and the distances between the edge of circuit board 61 and the edge of shield 65 is sufficient to prevent fringing field from entering the circuit board 61, shielding in the direction 69 may not be necessary.

In one example, the circuit board includes a motion or position sensor.

In another example, the circuit board includes a preamplifier.

In yet another example, the circuit board includes a digital storage medium including an identification number. The identification number may be used to identify the sensor head.

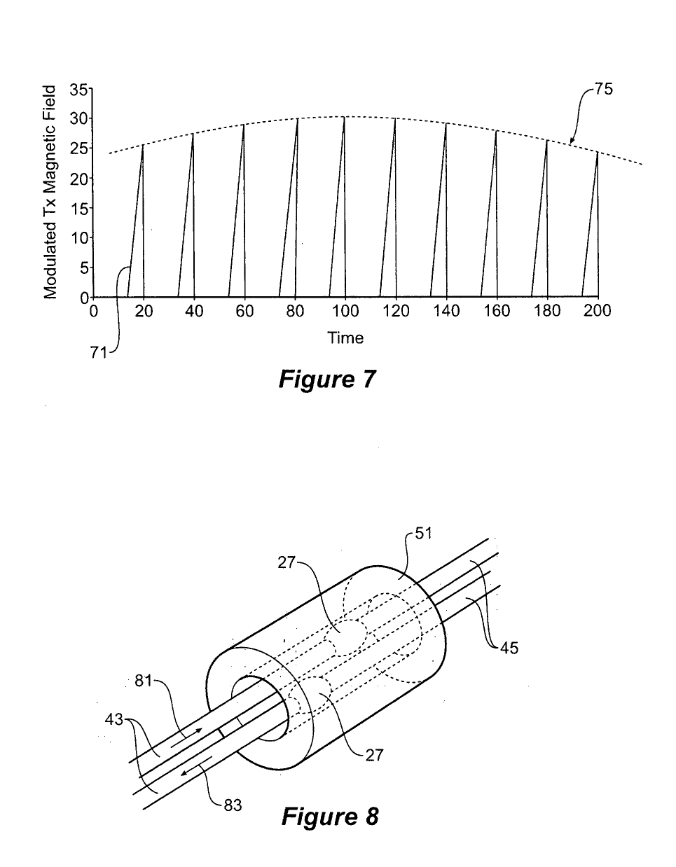

FIG. 7 is a simple graphical representation of a modulated time-varying response field at a point within the influence of the transmit magnetic field (for illustrative purposes only). Strictly speaking, the modulation illustrated is due to the influence of a volume of lossless magnetic material, but this invention does not rely on that condition in order to be efficacious.

The time-varying nature of the magnetic field is cyclic and is represented by the saw-tooth pulses 71. The modulation of the time-varying field is represented by the slowly varying amplitude 75 of the pulses.

A typical situation, where this modulation occurs is when metal detectors are used in fields whose soil has an appreciable magnetic permeability. Such soils are common in, but not exclusive to, goldfields. Variations in the distance between transmit winding and the surface of the soil will effect the modulation; so will spatial variations in the magnetic permeability of the soil as the sensor head is passed over them.

It is common for magnetic soils or matrices to have a significant contribution through the effect of “magnetic viscosity”. This produces a remanent magnetism in the soils or matrices after the applied magnetic field has been removed. In the development of metal detectors, the negation of their response to the effects of magnetic viscosity is the subject of much effort.

In PI detectors, the decay of remanent magnetism during the receive periods of the transmit cycle induces signals in the receive winding of a sensor head. If not negated through signal processing, these signals are strong enough to be confused with, or completely obscure, signals from sought targets. In many soils, the magnitude of the field reflected by the ground (response field) can be orders of magnitude greater, at the sensor head, than the fields reflected by most sought targets. A field of such magnitude has a significant effect upon the magnitude of the nett synchronous magnetic field at the sensor head.

Again, in the case of PI detectors, the effect of induced eddy currents in electrically conductive elements of the sensor head, while the currents are induced synchronously with the transmit cycle, extends as they decay into the zero-field sections of the transmit cycle, during which time the signals in the receive winding are processed for evidence of targets. The effect of this is to distort signals that would otherwise have been generated by the ground, adversely affecting the ability of a metal detector to negate the effects of magnetic viscosity.

In one embodiment of this invention, a tube of ferrite, whose μᵣ>>1 (such as 10), can be posited with its length axis approximately perpendicular to the field lines of the transmit magnetic field. The object to be shielded is located within the hollow of the tube such that the half-way point of the object is approximately at the half-way point of the length of the tube. The shielding tube is long enough that the length of shielding tube, beyond the extent of the shielded object, is preferably at least 1.5 times the inner diameter of the shielding tube.

Were the shielding material to have loss, or a complex permeability, it would, in effect, exhibit magnetic viscosity. Were the rate of decay of the remanent magnetisation of the material slow enough, as it is in magnetic ground, the modulation of the transmit field would produce a response field which modulates the magnitude of the remanent magnetisation of the shielding material, inducing a changing signal in the receiver of the metal detector. An exemplar of the shielding material needs to have very little remanent magnetisation during receive demodulation periods of a detector (during which receive signals are processed), so as to not produce a signal large enough to elicit indication of a detection.

Regardless of all else, the shield is preferably secured to some element of the sensor head that it is substantially fixed with respect to the windings within the sensor head, for example, by means of glue or epoxy. The shielding element distorts the transmit magnetic field, and small shifts in its relative position can induce detectable signals in the receive winding.

Many ferrites are made of material with non-zero conductivity. Like the electro-quasi-static shield incorporated in the sensor heads of many detectors, this conductivity is not great enough, nor the intended size of the magnetic shield big enough, for the shield to sustain eddy currents with TC long enough to be detected.

Generally speaking, the response of ferrite to changes in applied magnetic field is non-linear. As the intensity of the applied field increases, the relative permeability of the ferrite decreases. The rate of this decrease increases as the intensity of the applied field increases. In extreme cases, increasing the intensity of the applied field can reduce the relative permeability of the ferrite to near 1. As this relative permeability is reduced, so does the effect of shielding the electrically conductive elements of a sensing head from the response field.

In the case of shielding a solder joint connecting wires carrying electrical current, care must be taken to ensure that the current in the wires does not produce, at any time, a magnetic field that would magnetise the shield to the extent that its degree of magnetisation under the influence of applied fields becomes significantly non-linear. This would reduce the shielding effect of the material, by reducing its relative permeability. Referring to FIG. 8, if one of cables 43 carries current through the shield in one direction 81, the other one of cables 43 carries the return current through the shield in an opposing direction 83. In this manner the nett magnetic field, from the conducting wires, within the shield is substantially zero.

There is also the possibility that the shield is magnetically saturated by the applied transmit magnetic field. Whether the shield can be saturated depends upon the material of which the shield is made, the geometry of the transmit winding and the shield, and the intensity of the transmit field at the shield. Saturation can produce a significant reduction of the relative permeability of the shield while the field is applied. This effect is to be minimised when designing the shield.

The μᵣ of the material can be anything greater than 1, depending upon the degree of shielding required; as the μᵣ is increased, the likelihood of saturation increases. In the case of a ferrite tube with its axis lying horizontal with respect to the plane of the transmit winding, there will be two components of B-field orientated in opposite directions through the material of the tube, substantially cancelling each other. In this case, the nett field in the ferrite is much less than the equation B=μH suggests.

It is important to note that the invention described herein is addressing a problem different from those addressed by U.S. Pat. No. 4,890,064. U.S. Pat. No. 4,890,064 discloses use of parallel strands of individually insulated wire whose diameters are small enough to prevent the generation of eddy currents that have TCs long enough to affect, significantly, the detection of sought targets.

JP7296964(A) describes ferrites being used to prevent the generation of eddy currents in electrically conductive elements through time-varying magnetic fields transmitted by energised inductive coils. Said patent specification describes a shield, constructed of a magnetically shielding material, made of soft magnetic substance, interposed between a coil generating time-varying magnetic flux and any proximate metallic object that would wastefully sustain eddy currents and thereby dissipate energy in extraneous objects rather than the object that is intended to be heated through induction. It is evident that the goal is either the prevention of heating in some object that is not essential in the working of the invention, or the determination of the distribution of a generated field. The shields are required, and produce, their intended effect, regardless of whether their generated fields are temporally modulated by external objects.

In this invention, the motive is not the preservation of energy for the sake of it; were the transmit magnetic field not modulated by external magnetic or conductive matrices to produce variations in the response field, the generation of eddy currents in elements of the sensor head would have little effect upon the sensitivity of a moving metal detector.

A detailed description of one or more preferred embodiments of the invention is provided above along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the description above in order to provide a thorough understanding of the present invention. The present invention may be practised according to the claims without some or all of these specific details. For the purpose of clarity, technical material that is known in the technical fields related to the invention has not been described in detail so that the present invention is not unnecessarily obscured.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge of the technical field.

1. A method for improving a sensitivity of a metal detector by reducing an unwanted magnetic field generated by at least one electrically conductive element of the metal detector, the metal detector transmitting a transmit magnetic field into a soil and a possible target within the soil which in response generate a response magnetic field, the method including the step of:
redirecting at least a portion of the response magnetic field from entering the at least one electrically conductive element, wherein otherwise the at least one electrically conductive element within an influence of the response magnetic field generates the unwanted magnetic field due to a change in an intensity of the response magnetic field entering the at least one electrically conductive element, the redirecting adapted to reduce or eliminate the unwanted magnetic field generated by the at least one electrically conductive element thereby improving the sensitivity of the metal detector.

2. A metal detector capable of transmitting a transmit magnetic field and receiving a response magnetic field for detecting a target in a soil, including:
at least a magnetic field redirecting element for redirecting at least a portion of the response magnetic field from entering an at least one electrically conductive element, wherein otherwise the at least one electrically conductive element within an influence of the response magnetic field generates the unwanted magnetic field due to a change in an intensity of the response magnetic field entering the at least one electrically conductive element, the redirecting element adapted to reduce or eliminate the unwanted magnetic field generated by the at least one electrically conductive element thereby improving a sensitivity of the metal detector.

3. A metal detector according to claim 2, wherein the magnetic field redirecting element is made of a material with a relative magnetic permeability greater than 1.

4. A metal detector according to claim 3, wherein the relative magnetic permeability is a substantially real number over a predetermined range of operational frequencies.

5. A metal detector according to claim 3 or 4, wherein the material is ferrite.

6. A metal detector according to claim 2, wherein the metal detector includes a transmit coil for transmitting magnetic fields and a receive coil for receiving response magnetic fields; and wherein the at least one magnetic field redirecting element is substantially stationary with respect to the transmit coil and the receive coil.

7. A metal detector according to claim 6, wherein the transmit coil and the receive coil are the same coil.

8. A metal detector according to any one of claims 2 to 7, wherein the at least one electrically conductive element of the metal detector includes a volume of solder joint.

9. A metal detector according to any one of claims 2 to 7, wherein the at least one electrically conductive element of the metal detector includes a circuit board.

10. A metal detector according to any one of claims 2 to 7, wherein the at least one electrically conductive element of the metal detector includes a position or motion sensor.
